(19) United States
(12) Patent Application Publication
(10) Pub. No.: US 2012/0308864 A1
(43) Pub. Date: Dec. 6, 2012

(54) CELL BLOCK WITH LATERAL SUPPORTING OF THE CELLS

(75) Inventors: Jens Meintschel, Bernsdorf (DE); Claus-Rupert Hohenthanner, Hanau (DE); Holger Mikus, Kamenz (DE); Tim Schaefer, Harztor (DE)

(73) Assignee: LI-TEC BATTERY GMBH, Kamenz (DE)

(21) Appl. No.: 13/501,668

(22) PCT Filed: Oct. 7, 2010
(86) PCT No.: PCT/EP10/06141

§ 371 Date: Aug. 2, 2012

(30) Foreign Application Priority Data
Oct. 12, 2009 (DE) 10 2009 049 043.4

(51) Int. Cl. H01M 2/10

(52) U.S. Cl. 429/96

(57) ABSTRACT

The invention relates to an assembly composed of at least one galvanic cell and at least two frame elements, wherein one galvanic cell is respectively disposed between two frame elements, wherein the assembly forms a stack and has a tensioning device for bracing the assembly in the direction of the stack; wherein the galvanic cell comprises a flat main body and at least two current conductors, said main body having two flat sides and peripheral narrow sides; wherein each frame element comprises a plurality of, preferably four, beams connected to each other in a closed configuration and defining a free space therebetween; wherein the main body of the galvanic cell is received in the free space of two adjacent frame elements; and wherein at least in the region of the narrow sides of the main body, preferably beyond an edge in which the narrow sides transition into a flat side of the galvanic cell, the cross-sections of sections of the frame elements that face toward the free space are designed to follow the contour of the main body of the galvanic cell. In such a way, the galvanic cell can be laterally supported on the frame elements.

### CROSS-REFERENCE TO RELATED APPLICATIONS

This application is a National Phase application under 35 U.S.C. §371 of International Application No. PCT/EP2010/006141, filed Oct. 7, 2010 and published as WO 2011/045000 on Apr. 21, 2011, which claims priority to German patent application serial number DE 10 2009 049 043.4, filed Oct. 12, 2009, the entirety of each of which is hereby incorporated herein by reference.

### FIELD OF THE INVENTION

The present invention relates to a cell block, i.e. an arrangement of at least one galvanic cell and at least two frame elements, an electrical energy storage device with an arrangement of this type and a vehicle with an electrical energy storage device of this type.

### BACKGROUND

It is known to produce energy stores and in particular lithium batteries and lithium rechargeable batteries (in the context of this application, as is customary in automotive technology, the terms battery and rechargeable battery are used synonymously) in the form of thin plates. Energy stores of this type are called pouch cells, flat cells or coffee bag cells.

In order to achieve the voltages and capacitances desired in practice, for example in the case of automotive batteries, it is necessary to arrange a plurality of cells to form a stack and to interconnect the current conductors thereof in a suitable manner. The wiring of the individual cells conventionally takes place on a (generally defined as “upper”) narrow side of the cells, from which the current conductors protrude. Wiring arrangements of this type are shown in WO 2008/128764 A1, WO 2008/128769 A1, WO 2008/128770 A1 and WO 2008/128771. The current conductors and the connections thereof are exposed on the upper side in this case.

The inventors are also aware of an arrangement not provable in more detail by means of published documents, in which a plurality of flat cells are stacked between two pressure plates, the stack being held together by means of tension rods (threaded bolts or pan-head screws) which extend between the pressure plates. Here, the active parts of the storage cells bear against one another by means of the pressure of the tension rods.

A development which has not yet been publicly disclosed is further known to the inventors, according to which, flat cells with flat current conductors laterally protruding from opposite narrow sides are arranged in such a manner between frames that the current conductors are grasped by the frames by means of a clamping device and the cells are held in a block in this manner. The contacting in this case takes place in a positive manner by means of the clamping apparatus by means of contact elements which are also clamped between the current conductors. The clamping device consists of tensioning bolts which run through the current conductors in the region of the contact elements. The radial centring of the cells takes place for example by means of the conductors which bear against corresponding construction elements (noses, studs, strips, pins, etc.) of the frames or surround the same (e.g. holes in the conductors).

It is an object of the present invention to improve the structure according to the prior art in particular (but not only) with regard to the previously mentioned aspects. It is in particular an object of the present invention to create a battery, in which a plurality of individual cells are combined to form a block in an advantageous manner.

The object is achieved by the features described herein. Advantageous developments of the present invention described herein.

### SUMMARY

According to the present invention, an arrangement of at least one galvanic cell and at least two frame elements is suggested, one galvanic cell in each case being arranged between two frame elements, the arrangement forming a stack and having a clamping apparatus which clamps the arrangement in the stack direction; the galvanic cell having a flat main body and at least two current conductors, the main body having two flat sides and peripheral narrow sides; each frame element having a plurality of, preferably four, beams connected to one another in a closed manner, which define a closed space between themselves; the main body of the galvanic cell being accommodated in the free space of two adjacent frame elements; and at least in the region of the narrow sides of the main body, preferably up to beyond an edge at which the narrow sides merge into a flat side of the galvanic cell, sections of the frame elements facing the free space being constructed in a manner which in cross section follows the contour of the main body of the galvanic cell.

In the sense of the present invention, a galvanic cell is understood as meaning a device which is preferably structurally self-contained and capable of functioning alone, which device is also designed and set up for emitting electric current. This can in particular but not only be an electrochemical primary or secondary cell. In the sense of the present invention, the term can also however be applied, without limiting the generality, to capacitors, so-called supercaps (a particularly powerful type of capacitor), fuel cells or the like. Preferably, the present invention relates to secondary cells of a lithium type. In this case, in the sense of the present invention, a current conductor is understood as meaning a connection accessible from outside, which is connected to the electrochemically active parts in the interior of the galvanic cell and is also used as a pole of the cell.

The arrangement with a galvanic cell and two frame elements corresponds to the smallest possible size of the arrangement. Usually more than one galvanic cell will be present. The arrangement will ideally have as many individual galvanic cells in a suitable electrical interconnection as corresponds to the desired overall voltage and the desired overall capacitance.

In the sense of the present invention, a main body is understood as meaning the fundamental geometric manifestation of the galvanic cell without any appendages, notchings, tabs, fixing elements or the like which may protrude therefrom. According to the definition of the present invention, the main body is, with two flat sides and peripheral narrow sides, a flat square, that is to say plate-shaped, whereby roundings, chamfers and/or curves, concave or convex, should not be excluded.

In addition to the space between the beams of each frame element, a free space between adjacent frame elements also in the sense of the present invention encloses the space which connects the free spaces between the beams of the frame elements, in other words the gap between the frame elements.

Since, according to the present invention, at least in the region of the narrow sides of the main body, preferably up to beyond an edge at which the narrow sides merge into a flat side of the galvanic cell, sections of the frame elements facing the free space are constructed in a manner which in cross section follows the contour of the main body of the galvanic cell, a constant spacing between this edge region and the frame elements can be ensured in this edge region of the cell. As a result, the advantages of laterally supporting the cells on the frame elements and/or ensuring a secure centring of the cells at least in the radial direction during installation and during operation can also be achieved. Additional construction elements for lateral fixing of the cells can be dispensed with and therefore the constructive and production engineering outlay can be reduced. A narrow tolerance of the conductors to one another for purposes of adaptation with centring elements on the frames, which is difficult to realise without actual fixing in the jacket during welding, is not necessary. The forces on the connection between conductors and envelope film can be reduced, particularly in the case of large and heavy cells.

A development of the present invention is characterised in that the narrow sides of the main body of the galvanic cell have two side faces in each case, which extend in cross section from one of the flat sides towards a central plane defined between the two flat sides in each case, an angle between the side faces and the flat side of the main body of the galvanic cell adjacent thereto being 90° or larger. By means of the chamfering of the side faces, an even more reliable centring can also be achieved.

According to specific developments of the present invention, the regions of the frame elements which follow the contour of the main body of the galvanic cell are used as stop surfaces, bearing surfaces or pressure surfaces for the galvanic cell. To be more precise, if a spacing is maintained between the said surfaces in the assembled state, relative movements between the cells and the frame elements can also be limited. If the spacing becomes non-existent, relative movements of this type can also be prevented completely. If pressure is exerted between the surfaces, the cells can also be clamped via these surfaces alone or in addition to other measures.

A development of the present invention is characterised in that the main body of the galvanic cell has an active part which is designed and set up for accepting, storing and emitting electrical energy and is surrounded by two envelope film layers in the manner of a sandwich, whereby the envelope film layers protrude at least on two opposite narrow sides, preferably all the way round, laterally from the narrow sides of the main body and form a sealing seam which closes the active part in a sealing manner, and whereby at least sections of the sealing seam are grasped by beam sections of adjacent frame elements and are axially clamped by means of the clamping apparatus. In the sense of the present invention, an envelope film layer is understood as meaning a film which is single- or preferably multi-layered, is laid around the active part and forms a tear resistant, gas and liquid-tight envelope and also, if appropriate, an electromagnetic shielding. The envelope film can be one-piece—in this case, the active part is wrapped in the envelope film—or two-part—in this case, the active part is laid therebetween in the manner of a sandwich. Thus, an envelope film layer is located on each flat side of the galvanic cell. In the sense of the present invention, a sealing seam is understood as meaning a seam at which the envelope film layers are sealed—for example, without limiting the generality, adhesively bonded or welded. In the case of a single-piece envelope film, a sealing seam can run over the flat side of the galvanic cell and lie flat, whilst the two other sealing seams protrude from opposite narrow sides of the galvanic cell—for example as in the case of the envelope of a certain type of chocolate or muesli bar. However, it is also possible for all three sealing seams to protrude from the narrow sides. In the case of a two-part envelope film, the sealing seam runs preferably all around on all four narrow sides. If at least sections of the sealing seam are grasped by beam sections of adjacent frame elements and are axially clamped by means of the clamping apparatus (and the cell is held thereby), a simple and reliable construction of a cell block can also be realised. The particular shaping of the frame elements, which follows the contour of the main part of the galvanic cell in the edge region thereof, can also ensure that stresses in the envelope film, which may arise in the case of relative movements between the main part of the galvanic cell and the sealing seam fixed on the frame elements, are limited or prevented.

A development of the present invention is characterised in that the current conductors are electrically and mechanically connected to the active part, run between the two envelope film layers through the sealing seam and protrude outwardly from the main body, whereby they preferably protrude from two opposite narrow sides of the main body, and whereby the sealing seam, particularly in those sections in which the current conductors run therethrough, is grasped by the beam sections of the frame elements and are axially clamped by means of the clamping apparatus. In this arrangement, it is particularly included that the current conductors themselves are freely accessible from outside. If the galvanic cell is held at this point, then the connection of the current conductors to the active part in the interior of the cell can also be exploited for the more stable clamping of the cell, as this connection substantially captures relative movements of the active part. Also, the sluggish masses of connecting elements externally connected at the current conductors can be decoupled from those of the main body of the galvanic cell.

A development of the present invention is characterised in that an elastic element is arranged between the narrow sides of the main body of the galvanic cell and the sections of the frame elements following the contour thereof, which elastic element is preferably fixed on the frame element in a positive or materially bonded manner. In the sense of the present invention, an elastic element is in particular understood as meaning a component or a section which is flexible in a softly elastic manner. Such elements can for example be produced from elastomer, foam, rubber, expanded rubber or the like without limiting the generality, or also be a thin-walled profile which is elastically compressible in cross section and is for example produced from plastic without limiting the generality. Elastic elements of this type can also damp the stop or holding forces and thus further reduce the mechanical loads on the galvanic cell.

According to the present invention, an arrangement of at least one galvanic cell and at least two frame elements is also suggested, one galvanic cell in each case being arranged between two frame elements, the arrangement forming a stack and having a clamping apparatus which clamps the arrangement in the stack direction, the frame elements in each case having a plurality of, preferably four, beams connected to one another in a closed manner, which define a closed space between themselves, the main body of the galvanic cell being accommodated in the free space of two adjacent frame elements, the clamping apparatus having tensioning bolts which extend through anchor accommodating sections of the frame elements in the stack direction of the arrangement, the tensioning bolts running outside of a region of the galvanic cell with respect to a sectional plane perpendicular to the stack direction, the anchor accommodating sections being formed by webs or tabs which protrude from the beams of the frame element transversely to the stack direction, preferably in each case extending a beam, particularly in each case on both sides extending two parallel beams.

If the tensioning bolts run externally to a region of the galvanic cell, that is to say in particular also outside of a region of the current conductors, the further advantage that the current conductors can be structured constructively simpler compared to a likewise conceivable arrangement, in which the tensioning bolts run through the current conductors, and does not have to be geometrically tolerated as precisely can also be achieved. This helps also to reduce the production costs and minimise the scrap rate of the galvanic cells.

Both of the previously explained arrangements according to the present invention can be combined with one another particularly advantageously.

A development of the present invention is characterised in that the current conductors of the galvanic cell are freely accessible from outside. It is therefore also possible to attach and if appropriate also to remove connection elements again from outside.

A development of the present invention is characterised in that, with respect to a sectional plane transverse to the stack direction, the surface described by an envelope curve of the frame element completely accommodates the contour of the galvanic cell. In the sense of the present invention, an envelope curve is a closed line curve laid around the outer contour of a frame element, which is only convex when observed externally. Thus, externally accessible current conductors or other sensitive sections can also be reliably protected from unintentional contacting.

A development of the present invention is characterised in that the current conductors of a plurality of galvanic cells are connected to one another by means of connection elements in such a manner that the galvanic cells form a series connection or a parallel connection or a combination thereof within the arrangement. In this manner, a block with suitable electrical characteristics, in particular voltage and capacitance, can be created. In this case, the voltage of the block fundamentally corresponds to the sum of the cell voltages of the series-connected cells and the capacitance of the block corresponds to the sum of the capacitances of the parallel-connected cells, it being necessary to take voltage losses and cell defects into account in practice.

The present invention is in particular, but not only suitable for arrangements in which the galvanic cell(s) is/are (a) secondary cell(s), the active part having at least one material which contains lithium.

The present invention also relates to an electrical energy storage device, in particular a traction or drive battery for a vehicle, with one of the previously described arrangements according to the present invention, as well as a vehicle with an electrical energy storage device of this type.

The previous and further features, objects and advantages of the present invention become clearer from the following description, with reference to the attached drawings. In the figures:

### BRIEF DESCRIPTION OF THE DRAWINGS

FIG. 1 shows a perspective general view of a cell block according to an exemplary embodiment of the present invention.

FIG. 2 shows a perspective exploded illustration of a galvanic cell with two frames from the battery in FIG. 1.

FIG. 3 shows a sectional illustration of the cell block in FIG. 1 in a vertical longitudinal section.

FIG. 4 shows an enlarged illustration of a detail “IV” in FIG. 3.

FIG. 5 shows an enlarged illustration of a modified exemplary embodiment of the present invention, the illustrated detail corresponding to that in FIG. 4.

FIG. 6 shows a perspective enlarged illustration of a corner region of a frame according to the modified exemplary embodiment.

### DETAILED DESCRIPTION

It is to be pointed out that the illustrations in the figures are schematic and are limited to the reproduction of the most important features for the understanding of the present invention. It is also to be pointed out that the dimensions and size ratios reproduced in the figures are solely based on the clarity of the illustration and are in no way to be understood as limiting unless something else should emerge from the description.

A description of concrete embodiments and possible modifications thereof follow. Insofar as the same components are used in various embodiments, these are provided with the same or corresponding reference numbers. The repetition of features already explained in connection with an embodiment is largely avoided. Nevertheless, insofar as it is not mentioned otherwise explicitly or clearly technically nonsensical, the features, arrangements and effects of an embodiment are also to be transferred to other embodiments.

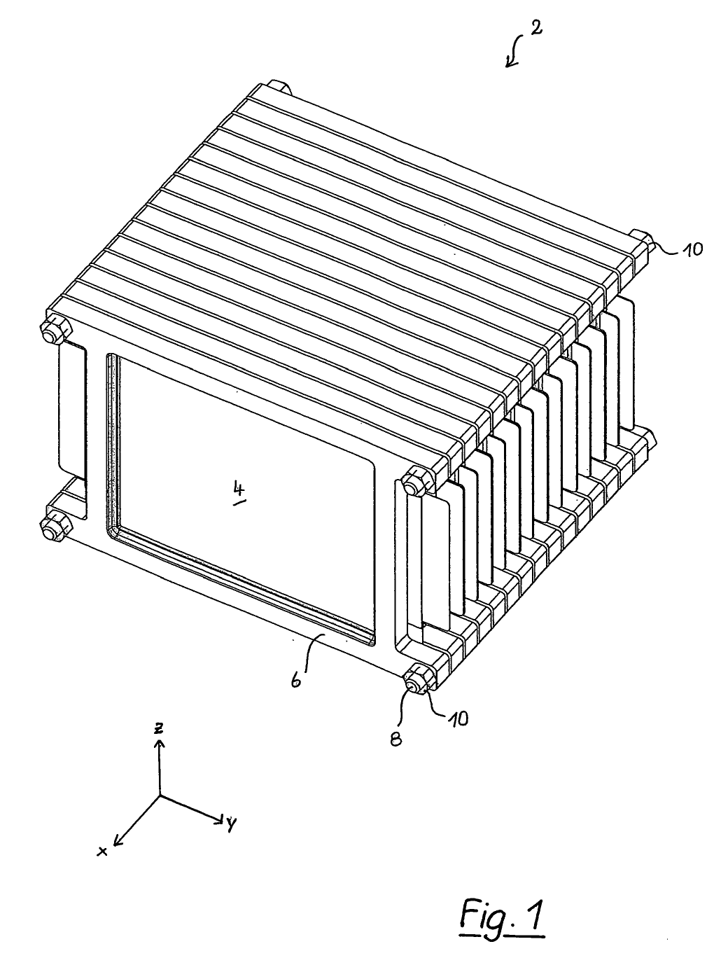

FIG. 1 is a perspective illustration of an assembled cell block 2 according to an exemplary embodiment of the present invention. In the cell block 2, a plurality of (here: fourteen) galvanic cells 4 (termed “cells” in the following) are held by a plurality of (here: fifteen) frames 6. In each case, two frames 6 grasp one cell 4. The cell block 2 is an arrangement in the sense of the present invention.

The stack made up of frames 6 and cells 4 is clamped by a plurality of (here: four) tensioning bolts 8 in such a manner that the stack forms an inherently stable block. The tensioning bolts 8 extend through holes (described later) in the frames 6 and are in each case clamped by two nuts 10, which are screwed onto the ends of the tensioning bolts 8. The tensioning bolts 8 and the nuts 10 are a clamping apparatus in the sense of the present invention.

In the figure, and this definition is retained in the context of this description, spatial directions are determined in such a manner that the x direction corresponds to the stack direction of the cell block 2, the y direction corresponds to the width direction of the cell block 2 and the z direction corresponds to the height direction of the cell block 2. The stack direction x is in the context of this invention also termed the axial direction, the y direction is termed the lateral direction and the z direction is termed the vertical direction. Each direction perpendicular to the axial (x) direction, particularly the y and the z directions, is also termed the radial direction. Thus, the x-y plane forms a horizontal plane and the x-z plane and the y-z plane form vertical planes. These direction definitions relate only to the cell block 2 itself, but do not preclude the shown arrangement according to the present invention being used in another global spatial location.

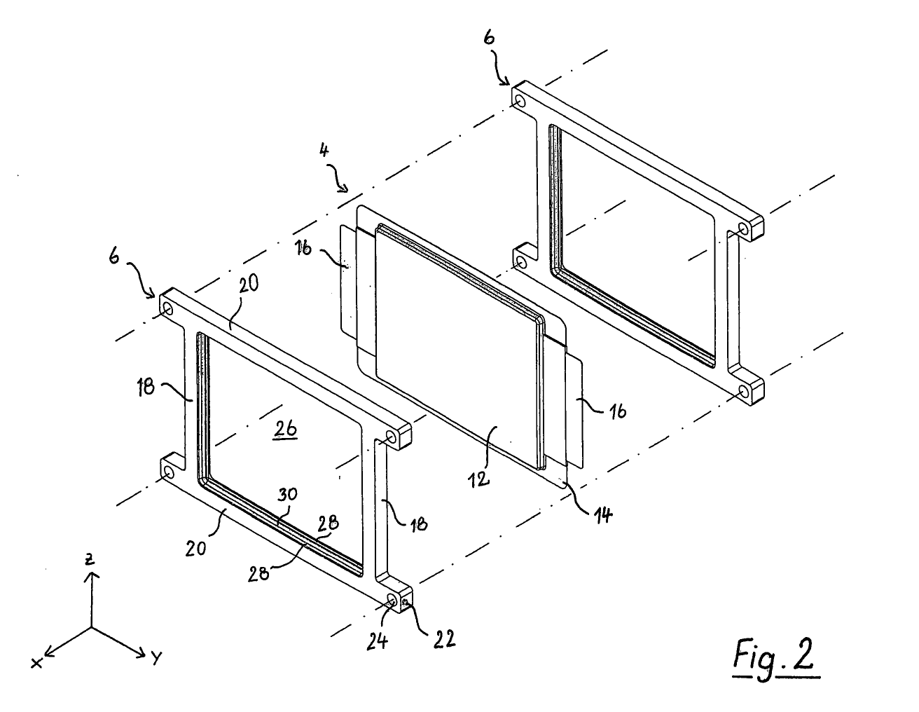

FIG. 2 is a perspective exploded illustration of a galvanic cell with two frames of the cell block according to FIG. 1.

The cells 4 are lithium ion cells in the form of so-called flat cells, also called pouch cells or coffee bag cells. These galvanic cells 4 have an active part (main part) 12 which has the shape of a flat square. An electrochemical reaction for storing and emitting electrical energy (charging and discharging reactions) takes place in the active part 12. The inner structure of the active part 12 (not illustrated in any more detail) corresponds to a flat laminated stack made up of electrochemically active electrode films of two types (cathode and anode), electrically conductive films for collecting and supplying or emitting electric current to and from electrochemically active regions, and separator films for separating the electrochemically active regions of the two types from one another. At least one type of the electrochemically active electrode films has a lithium compound. The cells 4 are therefore lithium ion, lithium polymer rechargeable battery cells or cells of the same type from the family of lithium batteries. Preferably, a separator is constructed with a non-woven made up of electrically non-conductive fibres, the non-woven being coated on at least one side with an inorganic material. EP 1 017 476 B1 describes a separator of this type and a method for the production thereof. A separator with the properties mentioned above is currently obtainable under the designation “Separion” from Evonik AG, Germany.

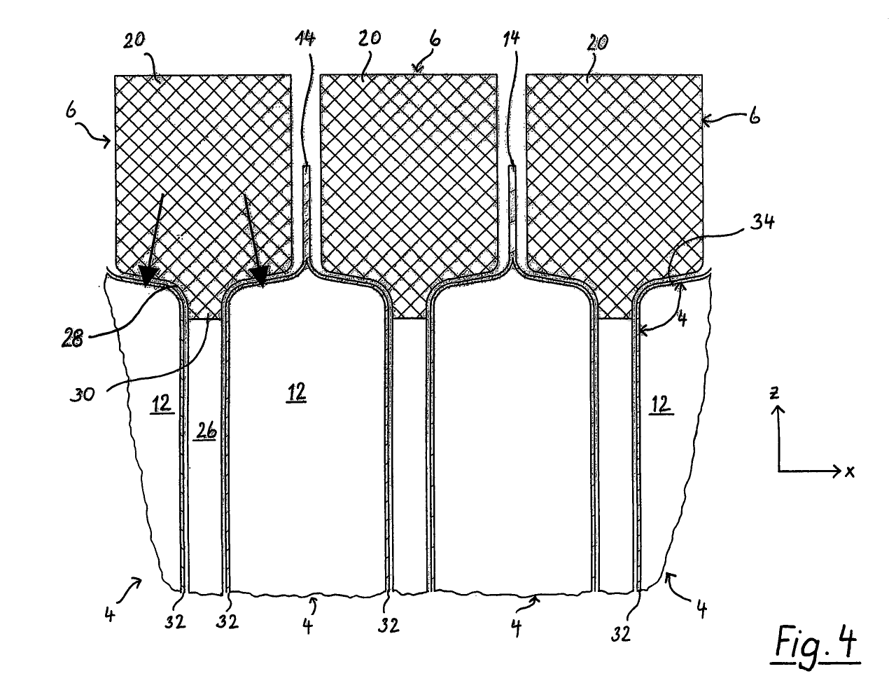

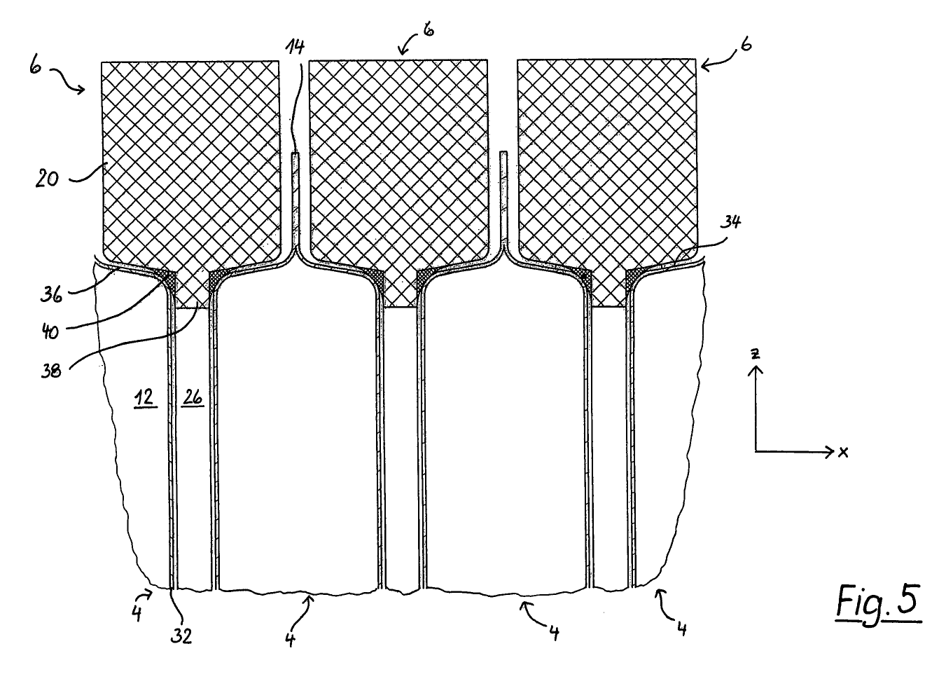

The active part 12 of the cell 4 is grasped in the manner of a sandwich by two films which are not described in any more detail in FIG. 2 (32 in FIGS. 4 and 5). The two films are welded at their free ends in a gas and liquid tight manner and form a so-called sealing seam 14 which surrounds the active part 12 as a peripheral inactive boundary zone which protrudes in the radial direction. The active part 12 is additionally evacuated so that the envelope films fit snugly. The active part 12 enclosed by the envelope films geometrically forms a main part of the cell 4 in the sense of the present invention without the sealing seam.

Two current conductors 16 protrude outwardly on the lateral (opposite in the y direction or width direction) narrow sides of the cell 4 through the sealing seam 14 out of the interior of the cell 4 and are accessible there as a two-dimensional structure. The current conductors 16 are connected to the electrochemically active cathode and anode regions in the interior of the active region 12 and are therefore used as cathode and anode connections of the cell 4.

The frames 6 are formed from four peripheral beams 18, 20, 18, 20. In this case, for the purposes of the description, the vertical beams 18 differ form the horizontal beams 20. The horizontal beams 20 continue beyond the boundaries of the vertical beams 18 as tabs in the horizontal direction. The tabs 22 can have a different cross section from the horizontal beams 20. In particular, they can, although they do not have to also have a different vertical thickness than the horizontal beams 20. A hole 24 extends through every tab 22 in the x direction (stack direction). The holes 24 are used for accommodating the tensioning bolts 8 (FIG. 1) which are only indicated here by means of their axial lines (dashed lines in FIG. 2). Consequently, the frames 6 of the cell block 2 are virtually threaded onto the retaining bolts 8 extending through the holes 24 of the tabs 22.

The beams 18, 20 form a closed frame and therefore outline a window 26. On the side facing the window 26 (the inner side), the beams 18, 20 in each case have two grooves 28 which are introduced in such a manner from the end faces in each case (that is to say sides, the surface normals of which run along the stack direction), that a peripheral web 30 protruding into the window 26 remains. The region in the radial direction between the grooves 28 and in the axial direction between the webs 30 of two adjacent frames 6 form a free space between frame elements in the sense of the present invention.

In the assembly (FIG. 1), the main parts of the cells 4 are located in this free space. The current conductors 16 extend through between the vertical beams 18 of the adjacent frames 6 and are freely accessible from the sides of the frames, whereby they are framed in the vertical direction by the tabs 22 and therefore are protected from accidental contactings. The current conductors 16 are accessible from the side and can thus be contacted by means of suitable connection elements (not illustrated in any more detail); also, the connections can also be disconnected without complete disassembly of the cell block 2 for example for maintenance or measurement purposes.

Although not illustrated in any more detail in the figure, the cells 4 are arranged in the cell block 2 (FIG. 1) with alternating polarity. That is to say, the cells 4 are arranged in such a manner that on each side on which the current conductors 16 are exposed, positive and negative poles (current conductors 16) alternate with one another in each case. Likewise not illustrated in any more detail in the figure are the already mentioned connection elements which act on the current conductors 16 and connect the same in a suitable manner to a battery or a rechargeable battery. A battery of this type is an electrical energy storage device in the sense of the present invention.

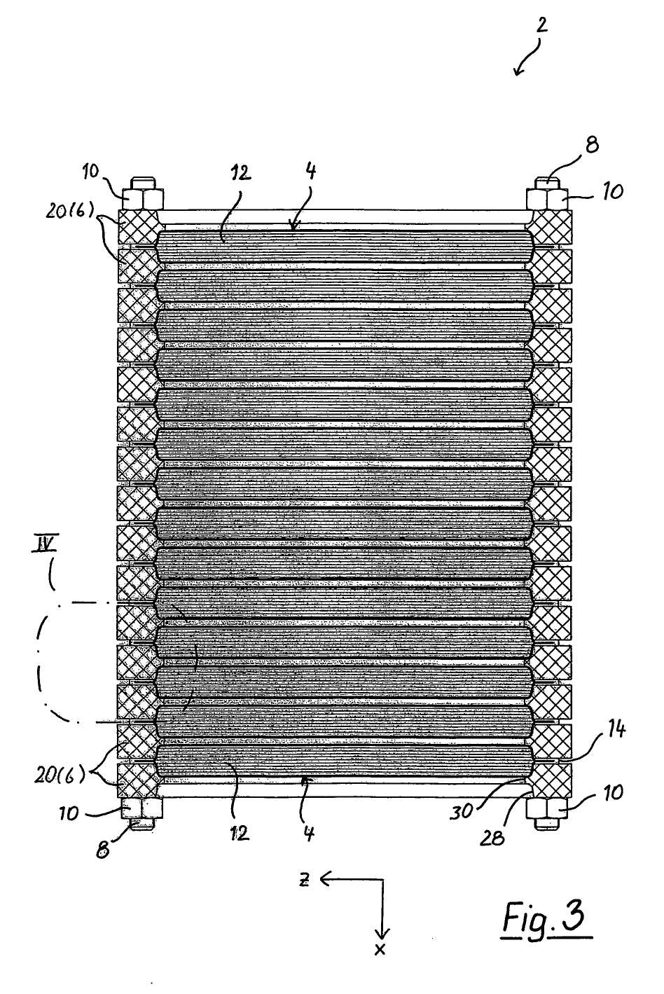

FIG. 3 is a sectional illustration of the cell block in FIG. 1 in the vertical longitudinal section, and FIG. 4 is an enlarged illustration of a detail “IV” in FIG. 3. The detail “IV” contains the cross sections of three successive horizontal beams 20 of corresponding frames 6 and a part of the cells 4 adjoining the same. The section in FIGS. 3 and 4 runs through the active part 12 and the sealing seam 14 of the cells 4 and the horizontal beams 20 of the frames 6. In FIG. 3, the layer arrangement of the films within the active part 12 is indicated with parallel lines; in FIG. 4, this illustration is dispensed with. In FIG. 4, the envelope films 32 are by contrast clearly illustrated. Each of the envelope films 32 is an envelope film layer in the sense of the present invention.

The narrow sides of the main body of the galvanic cell in each case have two side faces 34 which extend in each case in cross section starting from one of the flat sides towards a central plane defined between the two flat sides and then merge into the sealing seam 14. The grooves 28 and webs 30 follow the outer contour of the active part 12 of the cells 4 (that is to say the main body thereof) in the region of the narrow sides of the active part (side faces 34) and as far as beyond the edge at which the narrow sides merge into the flat side of the cell 4. In this case, the length (meaning the extent inwardly) of the webs 30 is limited to the edge region of the flat side of the cell 4. It is preferably not longer than half of the thickness, particularly preferably not longer than half of the half thickness, of the main body of the cell 4.

The side faces 34 and correspondingly also the grooves 28 have a flank angle φ to the cross-sectional plane x-y, that is to say the flat sides of the cells 4, which is 90° or larger. With suitable setting of the flank angle φ, a radial and axial centring or guiding between the side faces 34 and the grooves 28 can take place without the edge of the active part 12 colliding with the web 30. If the flank angle φ is chosen to be no larger than 120°, axial portions of guide forces can be limited and the fine adjustment of the spacing can be optimised in the axial direction. So, overall a gentle yet effective centring can be realised. 92.5° to 115° has established itself as a practicable range for the flank angle φ, a range of 95° to 110° being particularly preferred.

The sealing seam 14 is free between the horizontal beams 20 by some distance. The sections of the frame elements which follow the contour of the main body of the galvanic cell, that is to say in particular the bevelled faces and the base of the grooves 28, form bearing surfaces for the narrow sides (side faces 34) of the main body. The tensile stress of the tensioning bolts 8 is preferably set up in this case in such a manner that the grooves 28 exert pressure in the radial direction (transversely to the stack direction) onto the narrow sides (side faces 34) of the main bodies of the cells 6 (cf. arrows in FIG. 4). The cells 6 are therefore reliably held in their position, specifically in the radial as in the axial direction. The webs 30 in this case act as end stop and thus prevent an excessive lateral pressing of the side faces 34. By far the largest portion of the flat sides of the cells 6 is therefore kept clear from mechanical loading.

Although not shown in any more detail in the figure, stop elements can also be provided, which ensure that the axial spacing between frames 6 does not exceed a predetermined limit. Stop elements of this type can e.g. be discs which are pushed between the frames 6 over the tensioning bolts 8 in each case, or thickenings on the frame, particularly in the region of the tabs 22, or the like. Thus, clamping forces onto the side faces of the cells 4 can be limited even if the tensioning bolts 8 are tightened with high torques.

According to the previous exemplary embodiment, the grooves 28 and webs 30 follow the outer contour of the active part 12 of the cells in the edge region thereof in such a manner that pressure is exerted transversely to the stack direction onto the narrow sides (side faces 34) of the main bodies of the cells 6 and the sealing seam is free from clamping forces all around.

In an alternative, which is not illustrated in any more detail, the grooves 28 in the installed state have a smaller spacing from the side faces 34. The cells 4 are by contrast held in the region of the sealing seam 14, particularly where the current conductors 16 pass through. To this end, the thickness (the extent in the stack direction x) of the horizontal and vertical beams 20, 18 of the frames 6 and the depth of the grooves 28 are adapted to the thickness of the cells 4, the current conductors 16 and the envelope films 32 in such a manner that the vertical beams 18 come to bear against the envelope films 32 in the region of the passage of the current conductors 16 (cf. FIG. 2), before the grooves 28 can come to bear against the side faces 34 or the webs 30 can come to bear against the edge regions of the active parts 12 of the cells 4. Thus, the cells 4 are reliably clamped between the frames 6, the sealing between the current conductors 16 and the envelope films 32 being free from shear forces. Evasion movements of the active parts 12 with respect to the frames 6, particularly in the radial direction (directions perpendicular to the stack direction x), but also in the stack direction itself, are stopped at the inner contour of the frames 6 (at the groove 28 and the web 30) and thus kept within narrow tolerable boundaries. Unacceptable mechanical loads of the envelope films 32 and the connection points of the current conductors within the cells 4 can therefore likewise be prevented.

In this modification, the frames 6 can be produced from a material, for example a plastic which allows small elastic compressions, and dimensioned in such a manner that the grooves 28 bear gently against the side faces 34 of the cells 4 during setting of a certain contact pressure of the tensioning bolt 8. Thus, relative movements of the active parts 12 of the cells 4 with respect to the frames 6 can practically be excluded.

FIG. 5 shows a modified exemplary embodiment of the present invention in an illustration corresponding to the detail from FIG. 4. Except for the deviations discussed below, the structure of the cell block corresponds to that of the previously described exemplary embodiment.

In this modified exemplary embodiment, the grooves are replaced with notches 36 which follow the flank angle of the side faces 34 but merge with sharp edges (without any discernible rounding) into a web 38. (The single difference between the web 38 of this modified exemplary embodiment and the web 30 of the previous exemplary embodiment consists in the missing rounding in the merging to the notch 36.) An elastomer strip 40 is arranged and fixed in a positive and/or materially bonded manner in the corner between the notch 36 and the web 38, which strip contacts the edge between the shoulder 34 and the flat side of the active part 12 of the cell 4. Thus, a gentle supporting of the active parts 12 of the cells 4 within the frames 6 takes place. The notch 36 and the web 38 themselves do not contact the cell 4 in this exemplary embodiment. Any technically sensible soft elastic material, such as for example foam, rubber, expanded rubber or the like, or also a thin-walled profile which is elastically compressible in cross section and is for example produced from plastic without limiting the generality, can be used as elastomer in the sense of the present invention. The elastomer strip 40 is an elastic element in the sense of the present invention.

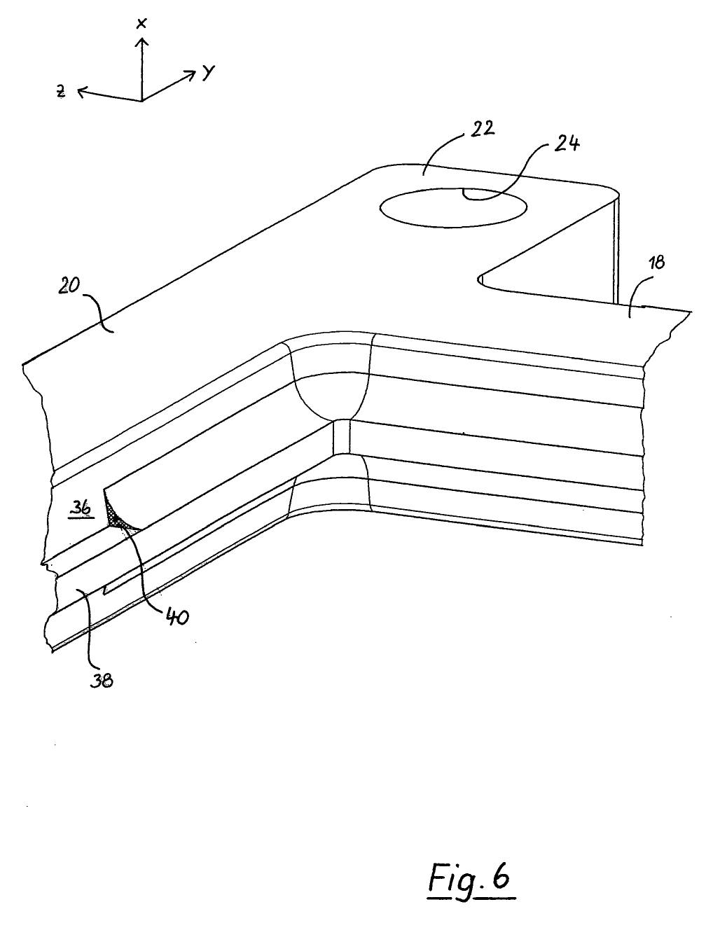

FIG. 6 is a perspective enlarged illustration of a corner region of a frame according to the modified exemplary embodiment, that is to say in the transition region between a vertical beam 18 and a horizontal beam 20.

The elastomer strip 40 is either adhesively bonded or sprayed on directly or fixed in some other manner. It may also be sufficient if the elastomer strip 40 holds solely by means of its residual stress, as it is held in a positive and non-positive manner in its position between the cell 4 and the frame 6 following the installation of the cell block 2.

Even in the case of this modified exemplary embodiment, stop elements can be provided, which ensure that when tightening the tensioning bolts 8, a certain spacing between adjacent frames 6 and thus a certain minimum spacing between the notches 36 and the side faces of the cells 4 is kept to, so that it is ensured that only the elastomer strips 40 press against the side faces with limited force.

Even this modified exemplary embodiment can alternatively be realised in such a manner that the cells 4 are also clamped on the sealing seam 14, preferably in the region of the passage of the current conductors 16. The elastomer strips 40 would in this case essentially only fulfil the object of the radial centring and the damping of axial evasion movements of the main bodies of the cells 4.

### MODIFICATIONS OF THE EMBODIMENTS

Although the present invention has previously been described with reference to concrete exemplary embodiments in terms of its essential features, it goes without saying that the present invention is not limited to these exemplary embodiments, but rather can be modified and expanded in the scope and field predetermined by the patent claims, for example, but not exclusively, as is indicated in the following.

In the previous exemplary embodiments, electrical energy storage cells of the type of a lithium ion secondary stores (rechargeable battery) have been described as galvanic cells. The term can however be applied in the context of the present invention to any type of electrical energy storage devices. It can be applied to primary stores (batteries in the true meaning of the word) and to secondary stores. Likewise, the type of electrochemical reaction for storing and emitting electrical energy is not limited to lithium metal oxide reactions, but rather, individual storage cells can be based on any electrochemical reaction. Likewise, capacitors, supercaps and the like can be arranged in a corresponding manner and [lacuna]

The number of cells and frames is irrelevant for the understanding and the scope of the present invention. More or less than fourteen cells 4 and fifteen frames 6 can be provided. However, generally one frame 6 more than cells 4 is present, so that each cell 4 is accommodated between two adjacent frames 6 in each case. For careful accommodation and distribution of the comparatively punctiform compressive forces which are introduced into the cell block by the tensioning bolts 8 via the nuts 10, discs or also end frames (not illustrated in any more detail) can be provided, on which the nuts 10 rest.

The sealing seam 14 can in a modification be folded along the upper and lower narrow side and there form a fold (not illustrated in any more detail) in each case, which stabilises the sealing seam at this point and prevents tearing. Insofar as the clamping of the cells 4 takes place at the sealing seam 14, the thickness of the fold can be adapted to the thickness of the current conductors 16 including film layers 32, in order to enable a residual stress through the vertical and horizontal beams 18, 20 given constant beam thickness.

### LIST OF REFERENCE NUMBERS

2 Cell block

4 Galvanic cell

6 Frame

8 Tensioning bolt

10 Nut

12 Active part of a cell 4

14 Sealing seam

16 Current conductors

18 Vertical beams of a frame 6

20 Horizontal beams

22 Tab

24 Hole

26 Window

28 Groove

30 Web

32 Envelope film

34 Side face

36 Notch

38 Web

40 Elastomer strip

x, y, z directions (x: axial; y: lateral, z: vertical)

It is explicitly pointed out that the preceding list of reference numbers is an integral part of the description.

1-17. (canceled)

18. An arrangement comprising:
at least one galvanic cell; and
at least two frame elements,
wherein one galvanic cell in each case is arranged between two frame elements, wherein the arrangement forms a stack and has a clamping apparatus which clamps the arrangement in the stack direction,
wherein the galvanic cell has a flat main body and at least two current conductors, wherein the main body has two flat sides and peripheral narrow sides,
wherein each frame element has a plurality of beams connected to one another in a closed manner, which define a closed space between themselves,
wherein the main body of the galvanic cell is accommodated in the free space of two adjacent frame elements, and
wherein at least in the region of the narrow sides of the main body, up to beyond an edge at which the narrow sides merge into a flat side of the galvanic cell, sections of the frame elements facing the free space are constructed in a manner which in cross section follows the contour of the main body of the galvanic cell.

19. The arrangement according to claim 18, wherein the main body of the galvanic cell has an active part which is designed and set up for accepting, storing and emitting electrical energy and is surrounded by two envelope film layers in the manner of a sandwich, wherein the envelope film layers protrude at least on two opposite narrow sides laterally from the narrow sides of the main body and form a sealing seam which closes the active part in a sealing manner, and wherein at least sections of the sealing seam are grasped by beam sections of adjacent frame elements and are axially clamped by means of the clamping apparatus.

20. The arrangement according to claim 18, wherein an elastic element is arranged between the narrow sides of the main body of the galvanic cell and the sections of the frame elements following the contour thereof, which elastic element is fixed on the frame element in a materially bonded manner.

21. The arrangement according to claim 18, further comprising an elastic element arranged between the narrow sides of the main body of the galvanic cell and the sections of the frame elements following the contour thereof, which elastic element is fixed on the frame element in a positive manner.

22. The arrangement according to claim 18, wherein the narrow sides of the main body of the galvanic cell in each case have two side faces which extend in cross section from one of the flat sides towards a central plane defined between the two flat sides, wherein an angle between the side faces and the flat side of the main body of the galvanic cell adjacent thereto is 90° or larger.

23. The arrangement according to claim 18, wherein sections of the frame elements which follow the contour of the main body of the galvanic cell form bearing surfaces for the narrow sides of the main body, wherein the bearing surfaces exert pressure in the radial direction onto the narrow sides of the main body.

24. The arrangement according to claim 18, wherein the current conductors are electrically and mechanically connected to the active part, run between the two envelope film layers through the sealing seam and protrude outwardly from the main body, and wherein the sealing seam is grasped by the beam sections of the frame elements and are axially clamped by means of the clamping apparatus.

25. The arrangement according to claim 18, wherein the clamping apparatus includes tensioning bolts which extend through anchor accommodating sections of the frame elements in the stack direction of the arrangement.

26. The arrangement according to claim 25, wherein the anchor accommodating sections are formed by webs or tabs which protrude from the beams of the frame element transversely to the stack direction.

27. The arrangement according to claim 18, wherein the clamping apparatus includes tensioning bolts which extend through anchor accommodating sections of the frame elements in the stack direction of the arrangement, wherein the tensioning bolts run outside of a region of the galvanic cell with respect to a sectional plane perpendicular to the stack direction, wherein the anchor accommodating sections are formed by webs or tabs which protrude from the beams of the frame element transversely to the stack direction.

28. The arrangement according to claim 18, wherein the current conductors of the galvanic cell are freely accessible from outside.

29. The arrangement according to claim 18, wherein, with respect to a sectional plane transverse to the stack direction, the surface described by an envelope curve of the frame element completely accommodates the contour of the galvanic cell.

30. The arrangement according to claim 18, wherein the current conductors of a plurality of galvanic cells are connected to one another by connection elements in such a manner that the galvanic cells form a series connection or a parallel connection or a combination thereof within the arrangement.

31. The arrangement according to claim 18, wherein the at least one galvanic cell is at least one secondary cell, wherein the active part has at least one material which contains lithium.

32. An electrical energy storage device, comprising:
an arrangement according to claim 18.

33. A vehicle, comprising:
an electrical energy storage device according to claim 32.
